(19) United States
(12) Patent Application Publication
(10) Pub. No.: US 2009/0167854 A1
(43) Pub. Date: Jul. 2, 2009

(54) Apparatus For Converting Film Images Into Digital Data

(75) Inventor: Chun Chieh Hsu, Chung Ho City (TW)

Correspondence Address: NEAL, GERBER, & EISENBERG, SUITE 1700, 2 NORTH LASALLE STREET, CHICAGO, IL, 60602, US

(73) Assignee: CRS ELECTRONIC CO., LTD., His Chi (TW)

(21) Appl. No.: 12/265,450

(22) Filed: Nov. 5, 2008

Related U.S. Application Data
(63) Continuation-in-part of application No. 12/164,034, filed on Jun. 28, 2008.
Application No. 12/164,034 is a continuation-in-part of application No. 12/003,398, filed on Dec. 26, 2007.

(51) Int. Cl. H04N 5/253

(52) U.S. Cl. 348/96; 348/E05.049

(57) ABSTRACT

A film conversion device that includes a body, a frame, a bottom brace and a bottom cover wherein the frame body is assembled to the upper portion of the bottom brace and then housed within the combination of the body and the bottom cover. A camera lens and image sensor is set above the frame and the combination of the camera lens and digital sensor is utilized to capture the images on the film and covert the images into digital data capable of being stored by a general purpose computing device or memory device. A display and memory may also be included to allow users to view, edit and capture images and to allow the film conversion device to operate on a stand-alone basis.

### CROSS REFERENCE

This application is a continuation-part of U.S. patent application Ser. No. 12/164,034 filed on Jun. 28, 2008, which is a continuation-in-part of U.S. patent application Ser. No. 12/003,398 filed on Dec. 26, 2007. Both of these applications are incorporated herein by reference in their entirety.

### FIELD OF THE INVENTION

The present invention relates generally to devices for transferring film images into digital data. More specifically, the present invention uses standard digital image capturing technology to convert film positives or negatives into digital images.

### BACKGROUND OF THE INVENTION

It is well known in the industry to create photographs by using light sensitive film (positive or negative film) to capture the desired image and projecting the desired image onto photo paper for subsequent developing. The developed film may then be dried and mounted for viewing and enjoyment. With the advent of digital photography, however, many users no longer wish to store hard copies of photographs. Instead, many users prefer to store photographed images electronically. Digital images are easier to store and are not as susceptible as hard copies of photographs to damage from being exposed to common elements. One option for addressing the storage issue for existing hard copies of photographs is to convert the existing photographs into digital images. To meet this desire, conversion devices were developed to convert film images into digital data. Existing devices generally use CRT scanning technology, which is more expensive and of lower quality than standard digital camera technology that captures digital images in one shot.

### SUMMARY OF THE INVENTION

A film conversion device that includes a body, a frame, a bottom brace and a bottom cover wherein the frame body is assembled to the upper portion of the bottom brace and then housed within the combination of the body and the bottom cover. A camera lens and image sensor is set above the frame and the combination of the camera lens and image sensor is utilized to capture the images on the film and covert the images into digital data capable of being stored by a general purpose computing device or memory device. A display and memory may also be included to allow users to view, edit and capture images and to allow the film conversion device to operate on a stand-alone basis.

### BRIEF DESCRIPTION OF THE DRAWINGS

FIG. 1 is a perspective view of the present invention.

FIG. 2 is an exploded view of the invention shown in FIG. 1.

FIG. 3 is a sectional view of the invention shown in FIG. 1 while assembled.

FIG. 4 is a perspective view of a film clamp for positive film for use with the invention shown in FIG. 1, with the film clamp in a closed position.

FIG. 5 is perspective view of a film clamp for negative film for use with the invention shown in FIG. 1.

FIG. 6 is a perspective view of the film clamp shown in FIG. 4, with the film clamp in an open position.

FIG. 7 is a perspective view of the film clamp shown in FIG. 5, with the film clamp in an open position.

FIG. 8 is a sectional view of the invention shown in FIG. 1 with a film clamp inserted within the device.

FIG. 9 is a partial sectional view of the invention shown in FIG. 8 from a different angle.

FIG. 10A is a sectional side view of a display that may be attached to an alternative embodiment of the present invention, as shown in FIG. 11, with the display in an open position.

FIG. 10B is a sectional side view of the display shown in FIG. 10A with the display in a closed position.

FIG. 11 is an exploded view of an alternative embodiment of the invention including the display shown in FIGS. 10A and 10B.

### DETAILED DESCRIPTION OF THE PREFERRED EMBODIMENT

While several embodiments of the present invention are shown in the drawings and described in detail, the present disclosure should be considered as an exemplification of the principles of the invention and is not intended to limit the invention to the embodiments so illustrated.

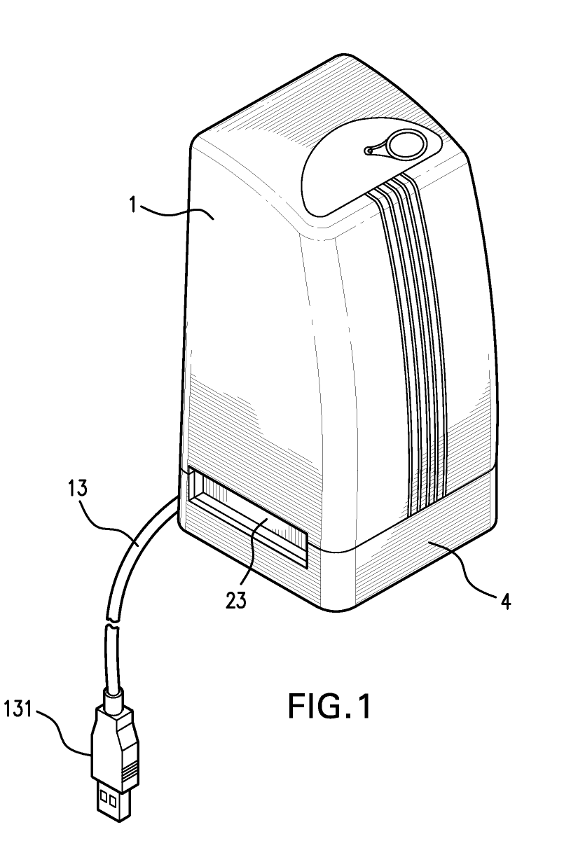

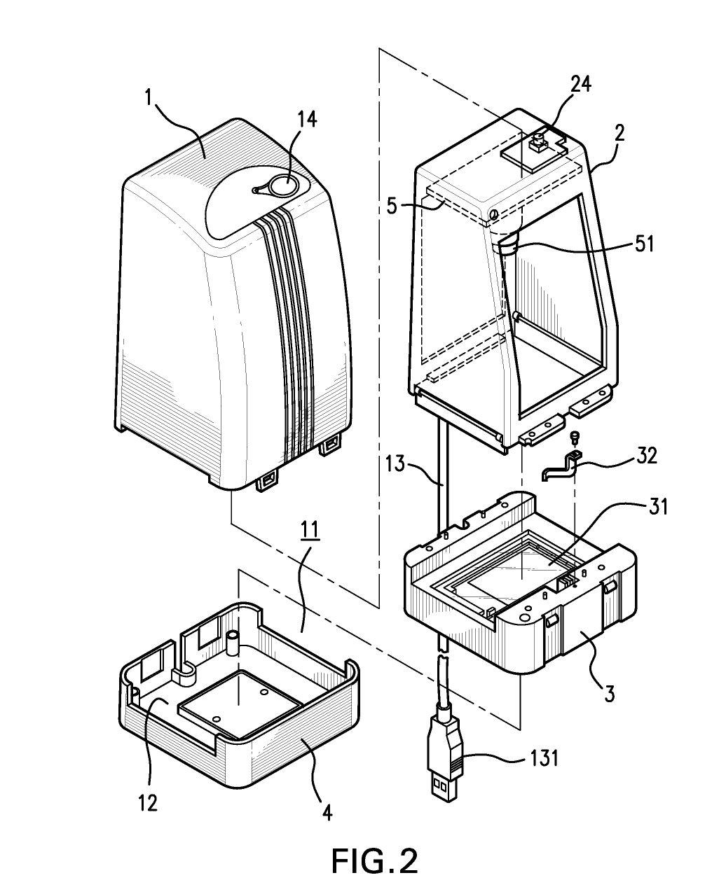

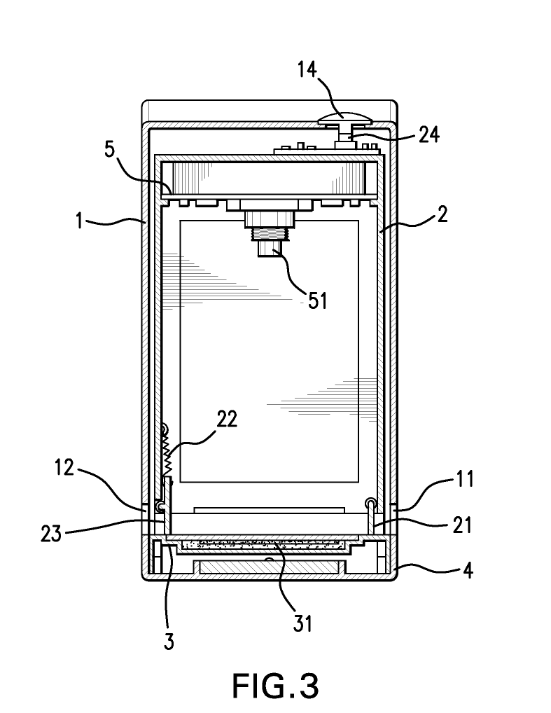

Please refer to those shown in FIG. 1-3. The present invention includes a body (1), a frame (2), a bottom brace (3) and a bottom cover (4). A PCBA (printed circuit board assembly) (5) is set within the upper portion of frame (2) and may include a camera lens (51) and image sensor (110) that is assembled in it. The bottom brace (3) is designed to be positioned under the frame (2) and may be attached to the frame with standard attachment means, such as screws, snap fittings, or other similar items. To project an image from film that is placed within the conversion device (100), a backlight mechanism (31) is set inside of the bottom brace (3). The backlight mechanism (10) is further comprised of a LED light assembly (160) that emits the level of light necessary to properly project the image onto camera lens (51). The LED light assembly (160) will include the appropriate number of LEDs and this number may vary depending on the needs of the film conversion device (100). In addition, the size of the LED light assembly (160) and the level of the light emitted from the LEDs may also vary based on the needs of the film conversion device (100), including the need to reduce the amount of power that is required to operate the film conversion device (100). Other solid state lighting devices may also be used, such as cold-cathode, fluorescent lamps.

To assist with alignment and assembly of the frame (2) and the bottom brace (3), a position wedge may be provided. Once the frame (2) and the bottom brace (3) are assembled, they may be housed inside the body (1). To fully enclose the frame (2) and the bottom brace (3), the bottom cover (4) is fixedly attached to the body (1) from underneath the bottom cover (4).

To form an inlet opening (111) and an outlet opening (112) for receiving film inside the conversion device (100), the bottom cover (4) may include two linked long grooves (11), (12). The inlet and outlet openings (111), (112) are formed by a combination of the two linked long grooves (11), (12) and the two sides of body (1). The combination of the inlet and outlet openings (111), (112) form passage whereby a film clamp, which will be described in greater detail below, may be passed through the film conversion device (100) to allow digitization of various images. To keep dust and other debris from entering the body (1) of the conversion device, the frame may include an inlet dust-proof door (21), which uses a torsion spring for to remove the inlet dust-proof door (21) back to position, and an outlet dust-proof door (23), which uses a tension spring (22) to remove the outlet dust-proof door (23) back to its desired position. As expected, the inlet dust-proof door (21) is associated with the inlet opening (111) and the outlet dust-proof door (23) is associated with the outlet opening (112). One end of the tension spring (22) is attached to the frame (2) and the other end of the tension spring is attached to the outlet dust-proof door (23). The inlet and outlet dust-proof doors (21), (23) are set at locations inside the frame (2) to cover the openings (111), (112) that are formed within long grooves (11), (12).

For connecting the internal circuit with a computer and transferring data to the computer through a connector (131), a connecting cable (13) is provided. The connecting cable (13) may run on the outside of the frame (2), but within the (body) before exiting the conversion device (100). Although it is currently envisioned that the connecting cable (13) will exit the conversion device (100) at the bottom side of the bottom cover (4), it should be obvious to those with skill in the art that the connecting cable (13) may exit the conversion device (100) at various points without departing from the teachings of the present invention.

To cause the conversion device 100 to capture an image, a user may depress a button (14) located on the upper portion of body (1). The button (14) may also be located on other areas of the body (1) so long as it is relatively easy to access. The button (14) may be further designed to interact with a switch (24) that is located beneath the body (1) and that may be attached to the frame (2). The interaction between the button (14) and the switch (24) is mechanical in nature, but an electrical or wireless connection between the button (14) and the switch (24) may also be employed. It should be obvious that the button (14) and switch (24) are designed to control the operation of the camera lens (51) and image sensor (110) and to initiate the digitization of images that are projected from the film onto the camera lens (51) and captured by the image sensor (110), and that this function is capable of being performed in a multitude of other manners. Thus, the disclosure related thereto should not be viewed as limiting the scope of the present invention.

For receiving images that are projected from the film, the film conversion device (100) includes camera lens (51). While there are a variety of different types of lenses that are capable of capturing images, the present invention uses a four glass lens. Other types of lenses may also be employed by the film conversion device (100) without departing from the teachings of this invention and are well-known in the industry.

For capturing images that are received by the camera lens (51) and converting them to a digital signal, an image sensor (110) may be provided. It should be obvious to those with skill in the art that these images are captured as single images versus other methods for capturing images, such as scanning the image. For example, a CMOS sensor may be used as the image sensor (110) and operate in combination with the camera lens (51). Other types of sensors or processing chips may also be used, such as CCD sensors. An important attribute for CMOS sensors is that they have lower power consumption relative to other image sensors. The image sensor (110) may capture images a various resolutions and the resolution level for the image sensor (110) is an important factor. For example, the present invention is designed to include a image sensor (110) that captures images at a resolution of up to 5 mega-pixel and that operates at up to 12 MHz. For a more detailed example of the operating specification for a image sensor see the sensor data sheet for the OV5610 CameraChip by Omni Vision. Image sensors that operate faster or at higher resolutions may also work with the present invention. Additionally, it should be obvious that the camera lens (51) and image sensor (110) may be combined into a single unit or module or exist as separate components, as desired.

To process the digital signal that is produced by the image sensor (110) and convert it into the proper data format, a digital signal processor (115) may also be provided. More specifically, the digital signal processor (115) receives a digital signal from the image sensor (110) that correlates to the image that is received by the camera lens (51). The digital signal processor (115) then converts the digital data that is representative of the image that was received by the camera lens (51) into a JPEG format, although other formats may also be utilized. The digital signal processor (115) also acts as an interface between the image sensor (110) and a general purpose computing device. It is possible that the digital signal processor (115) may also be formed as part of a more general microprocessor, which is defined as any hardware device for executing software, particularly software stored in memory. Therefore, any custom made or commercially available processor, such as a central processing unit (CPU), an auxiliary processor, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation.

To power the film conversion device 100, the film conversion device 100 requires 5 V to operate and is designed to receive DC power. It should be obvious, however, that the film conversion device (100) may also be adapted to run on AC power or via batteries. The film conversion device (100) may also use different components to limit the power consumption of the film conversion device 100, such as by using a image sensor (110) that has a low-power requirement.

For transmitting digital images to outside storage devices or a general purpose computing device, the film conversion device 100 includes a universal serial bus (“USB”) port (120). USB ports are well-known in the industry and are used to connect various electronic devices directly to general purpose computing devices and to facilitate the high speed transfer of information between an electronic device and a computer. Other data ports may also be used to transfer information for the film conversion device 100 to general purpose computing devices, such as serial, parallel or similar data ports, and improved means for data transfer that may be developed in the future that may also be employed. The film conversion device (100) may use any of the other available options for transferring data from the film conversion device (100) to a storage device or general purpose computing device.

The data that is representative of the digital image that has been captured by the film conversion device (100) may be compressed into a variety of different formats, including as a JPEG, TIFF or RAW, or other similar formats, and transferred to a general purpose computing device via the USB port (120). General purpose computing devices may include personal computers (PC; IBM-compatible, Apple-compatible, or otherwise), personal digital assistants, cell phones, workstations, minicomputers, or mainframe computers. In addition, as is well-known in the industry, each of these general purpose computing devices may include electronic memory, a display, an input device and an output device or port. The above-referenced list of general purpose computing devices should not be viewed as being exhaustive or limiting in any way. The film conversion device (100) may also employ existing technology to communicate with general purpose computing devices via wireless means. Wireless data communication is also well-know in the industry and it should be evident that any existing or future developed technology for accomplishing wireless communication could be utilized.

To transfer digital data from the image sensor (110) to a general purpose computer via the USB port, the film conversion device (100) may also include bridge processor (150). Bridge processors are devices that operates as a data link between one device and another and whose function is to connect and pass packets of information between the two devices.

To control the relationship between the film and the lens (51) and to keep the film flat, positive film clamps (6), which will be described in more detail below, may be used. The positive film clamps (6) will assist with maintaining the distance between the film and the lens (51). Although varying distances may be utilized by the film conversion device (100), the present invention maintains a distance of approximately 80 mm between the camera lens (51) and the film. The positive film clamps (6) will also compress the film and thereby keep it from becoming concave or convex in relation to the lens (51). Without the positive film clamps (6), there is a possibility that the image that is projected on the lens (51) could be distorted. Controlling the distance between the film and the lens (51), the amount of light projected on the film and limiting the exposure of the film to outside, ambient light is crucial to guarantying a consistent and high-quality digitization of the image contained on the film.

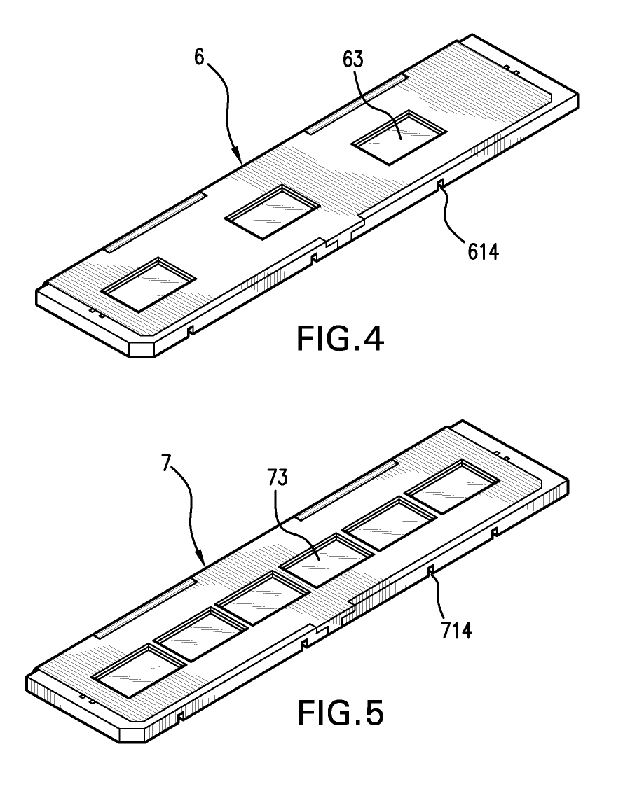

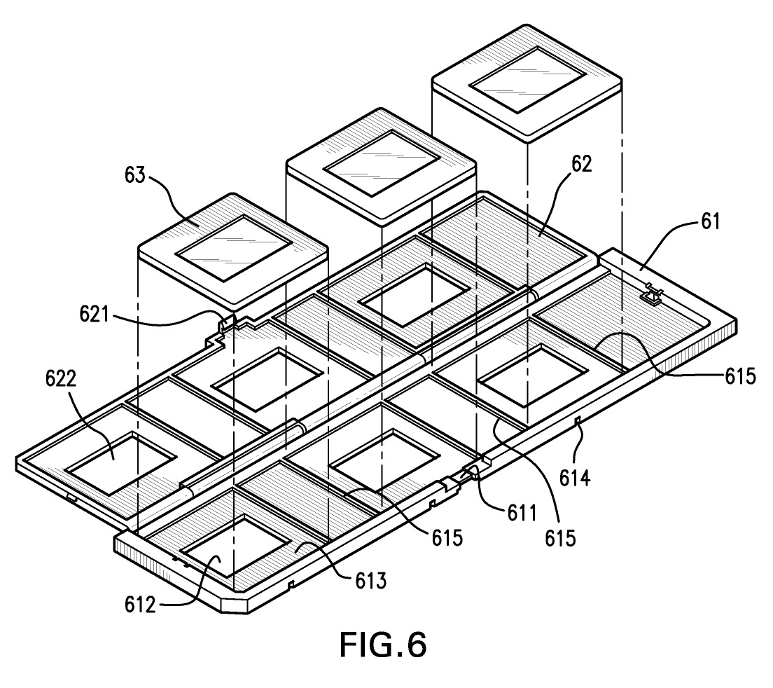

As shown in FIGS. 4 and 6, the positive film clamps (6) include a lower shell (61) and an upper shell (62) being pivotally connected at one side. The combination of the lower shell (61) and the upper shell (62) create a compartment capable of receiving film negatives or positives. Moreover, the pivotal connection between the lower shell (61) and the upper shell (62) allow users to access the compartment that is formed by the lower shell (61) and the upper shell (62) and to position film negatives or positives within the compartment. To releaseably attach the other side of the lower shell (61) to the upper shell (62), a clip (621) may be included on the upper shell (62) and a clip-assembly portion (611) may be included on the lower shell (61). When the clip (621) and clip assembly portion (611) are connected to one another, they secure the non-pivoting side of the positive film clamps (6) together. The clip (621) and the clip-assembly portion (611) may also be reversed with respect to the upper shell (62) and the lower shell (61) if desired.

Several square openings (612) are included in the lower shell (61) and the upper shell (62) for receiving positive film or slides, and the square openings (612) in the lower shell (61) and the upper shell (62) are aligned to facilitate receipt of the positive film or slides. To properly direct the image from the positive film to the lens (51), the lower shell (61) includes several concave portions (613). As shown in FIG. 6 and to assist with positioning the positive film properly with respect to the square openings (612) of the positive film clamp (6), the lower and uppers shells (71), (72) of the positive film clamp (6) may also include elongated walls (615) that are separated by a distance that is equal to the width of the positive film or slide. This will allow the positive film to rest within the positive film clamp (6) and prevent the positive film from shifting in a parallel direction as compared to the direction in which the positive film clamp (6) will be feed to the film conversion device (100). It is also possible to use different sized positive film or slides by adjusting the size of the square openings (612) and the location of the elongated walls (615) to correspond with the size of the positive film or slide being inserted into the positive film clamp (6). In addition, it is also possible to increase the size of the body (1) to accommodate positive film that is oversized. Once the upper and lower shells (61), (62) the clip (621) and clip assembly portion (611) are fixedly attached, the positive film should be aligned with the square openings (612), (622) and directed at the lens (51). It should be obvious that the elements described in connection with the lower and upper shells (61), (62) may be reversed and interchanged without affecting the underlying teaching of the present invention.

For properly positioning the horizontal relationship between each of the film positives and the lens (51), the lower shell (61) may include several positioning grooves (614). More specifically, the positioning grooves (614) are formed on the outside portion of the lower shell (61), as shown in FIG. 6. This allows a user to slide the positive film clamp (6) through the openings (111), (112) that are formed within the film conversion device 100 and to quickly align the positive film or slide that the user wishes to digitize by aligning one of the grooves (614) with a corresponding projection located on the film conversion device (100).

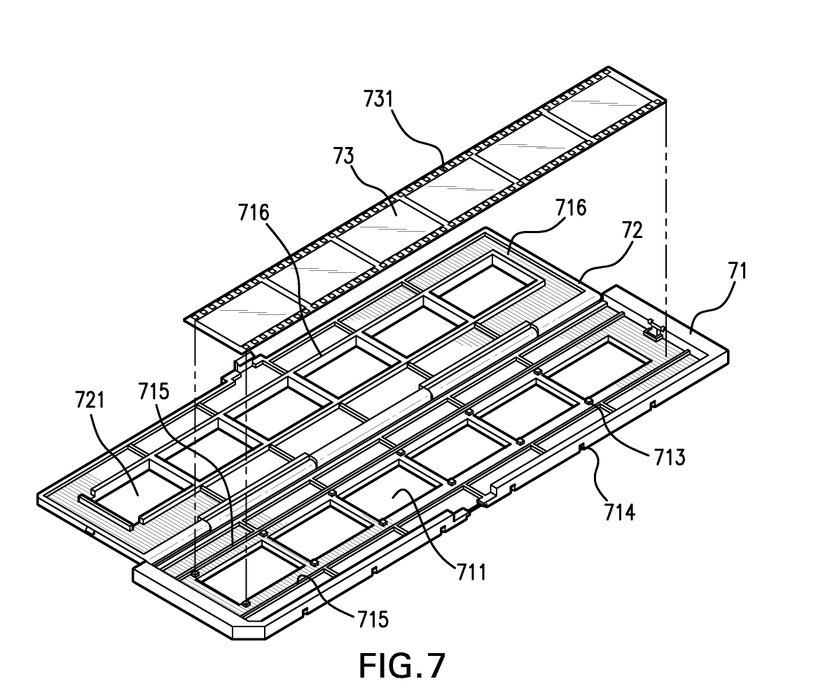

Similar to the positive film clamp (6), the film conversion device (100) may also work with a negative film clamp (7). Further, as shown in FIGS. 5 and 7, the general structure of the negative film clamp (7) is the same as that of the positive film clamp (6). For example, a lower shell (71) and (72) are pivotally connected at one side and the combination of the lower shell (71) and upper shell (72) create a compartment capable of receiving negative film (73). The pivoting connection between the lower shell (71) and the upper shell (72) is achieved by providing several hinges. The pivotal connection between the lower shell (71) and upper shell (72) allow users to access the compartment that is formed between the lower shell (71) and the upper shell (72) and to position negative film (73) within the compartment. To releasably attach the non-pivoting side of lower shell (71) to the non-pivoting side of upper shell (72), a clip (717) may be included on the upper shell (72) and a clip-assembly portion (716) may be included on the lower shell (71). When the clip (717) and the clip-assembly portion (716) are connected to one another, they secure the non-pivoting side of the negative film clamp (7) together. It should be obvious that the clip (717) and clip-assembly portion (716) may also be reversed with respect to the upper and lower shells (72), (71) if desired. Long grooves (11), (12) and openings (111), (112) operate in the same manner with respect to the negative film clamps (7) as these elements operate in connection with the positive film clamp (6). The long grooves (11), (12) and openings (111), (112) allow users to insert film into the film conversion device (100) for digitization without requiring the user to open the body (1) of the film conversion device (100), which increases the ease in which the user may feed images to the film conversion device (100) and digitize those images. In addition, by not having to open the body (1) of the film conversion device (100), it is easier to limit the amount of debris or dust that is able to enter the body (1) of the film conversion device (100).

To facilitate the attachment of the negative film to the negative film clamp (7), several protrusion rods (713) are provided. The protrusion rods are formed inside the lower shell (71) and interact with the small holes (731) that are formed on both sides of negative film (73). The protrusion rods (713) may also be formed on the upper shell (72) instead of on the lower shell (71). The negative film clamp also includes more square open holes (721), (711) in upper shell (72) and lower shell (71), as compared to the positive film clamp, to accommodate the smaller dimensions of the image frames. As shown in FIG. 7 and to assist with centering the negative film within the negative film clamp (7), the lower shell (71) of the negative film clamp (7) may also include elongated walls (715) that are separated by a distance that is equal to the width of the negative film. This will allow the negative film to rest within the negative film clamp (7) and prevent the negative film from shifting perpendicular as compared to the direction in which the negative film clamp (7) will be feed to the film conversion device (100). To compress or flatten the negative film once it is placed within the negative film clamp (7), the upper shell (72) may also include square projections (716) that surround the perimeter of the square open holes (721). Therefore, when the negative film is positioned within the negative film clamp (7), the square projections (716) will press own on the negative film and flatten it with respect to the negative film clamp (7). It should be obvious that the elements described in connection with the lower and upper shells (71), (72) may be reversed and interchanged without affecting the underlying teaching of the present invention.

Several grooves (718) are also set at the outside edge of one side of lower shell (71). This allows a user to slide the negative film clamp (7) through the openings (111), (112) that are formed within the film conversion device 100 and to quickly align the negative film that the user wishes to digitize by aligning one of the grooves (614) with a corresponding projection located on the film conversion device (100). Although the negative film clamp (7) is designed to operate with 35 mm film, it is also possible to use different sized film by adjusting the size of the square open holes (721) and the location of the protrusion rods (713) to correspond with the size of the film being inserted into the negative film clamp (7) and the location of the small holes (731) that are formed on both sides of the negative film (73). In addition, it is also possible to increase the size of the body (1) to accommodate film that is oversized.

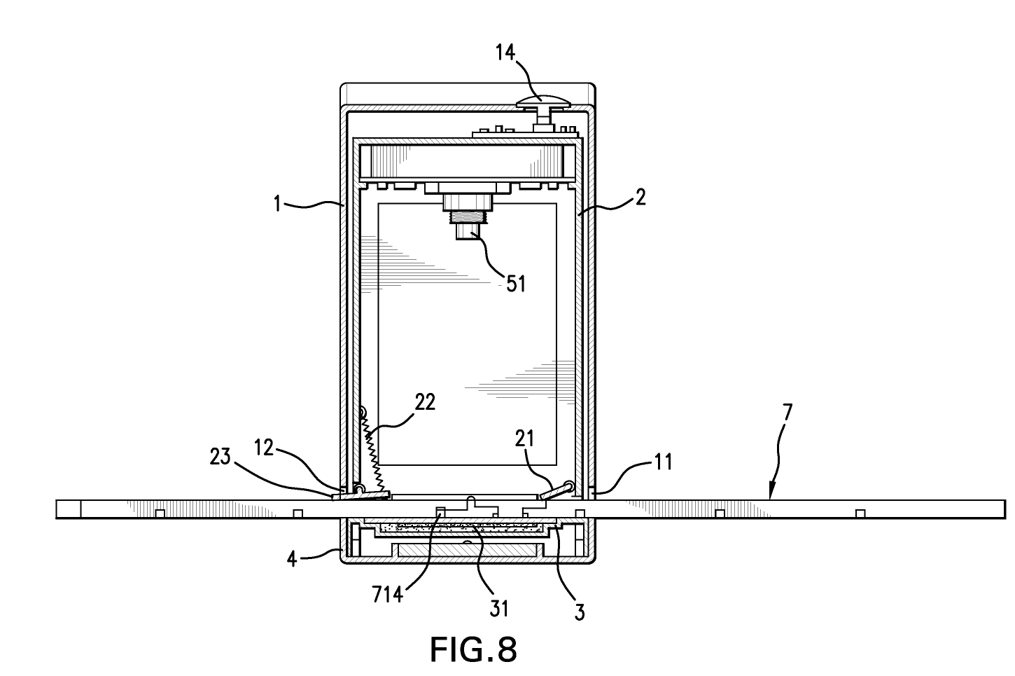

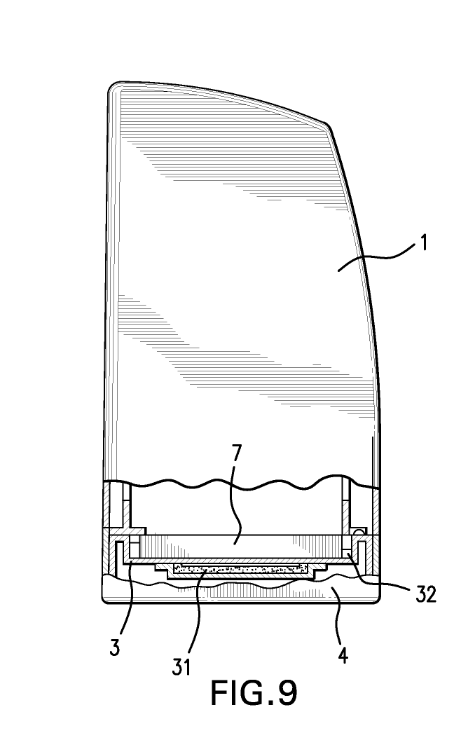

By way of example, FIG. 8 shows a negative film clamp that holds negative film (73). The negative film clamp (7) is inserted within the long groove (11) of the body (1) and once one of the grooves (718) are aligned with corresponding projections, the image that is contained on the negative film (73) that is positioned in the respective square open hole (721), (711) will be aimed at the camera lens (51). As shown in FIG. 9, the positioning wedge (32) is just snap-fit with a related positioning hole (714) to obtain secure positioning. Then, the back light mechanism (31) can be activated to emit the light and project the image on the negative film (73) onto the camera lens (51). The back light mechanism (31) may be activated by a general purpose computing device through connecting cable (13) or by directly pressing the button (14). The images taken from the camera lens (51) are processed by software programs that may be stored on the image sensor (110) and converted into digital data that is then sent to a general purpose computing device for modification or direct storage. Afterward, the film clamp (7) can be pushed toward the outlet end or long groove (12) and another image may be queued up for digitization.

Once the images imprinted on the negative film (73) have all been converted, the negative clamp (7) may be removed from the outlet end or long groove (12) and the negative film (73) may be removed from the film clamp (7). This allows the film inside to be replaced again and different film to be digitized as well. The method for digitizing positive film is analogous and substantially the same as the process for digitizing negative film (73). The positive film clamp (6) and the negative film clamp (7) are preferably made of a lightweight, yet sturdy, material such as plastic, which may be extruded or blow molded to take the proper form as needed.

In sum, the present invention may convert positive and negative films into digital data quickly and easily, which allows the user to modify the image contained on the positive or negative films and to store those images electronically. Thus, the present invention is rich in practicality and conforms to the requirements necessary to be patentable.

To convert, view and store images that are converted into digital data, the film conversion device (100) may also require memory (300). The memory (300) may comprise read only memory (ROM), a hard disk drive for reading from and writing to a hard disk, a magnetic disk drive for reading from and writing to a magnetic disk, and/or an optical disk drive for reading from and writing to a removable optical disk or any other suitable data storage device. The hard disk drive, magnetic disk drive, and optical disk drive may be connected to processing unit via a system bus and a hard disk drive interface, a magnetic disk drive interface, or an optical disk drive interface, respectively, or other suitable data interface. The drives and their associated computer-readable media provide a means of non-volatile storage for the computer executable instructions and any other data structures, program modules, databases, arrays, digital data, etc. utilized during the operation of the film conversion device (100). Other non-volatile storage may also be employed, and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Memory (300) may also have a distributed architecture where various components are situated remote from one another, but are still accessed by processor (400), and may be removeable, such as removable memory cards, flash memory cards, SD cards, etc. These removable memory devices are well-known in the art and are produced in a number of different formats, sizes and memory levels. The type of memory, the level of memory, and the integration of the memory do not have any bearing on the scope of the present invention and any devices that store data may be used in connection therewith.

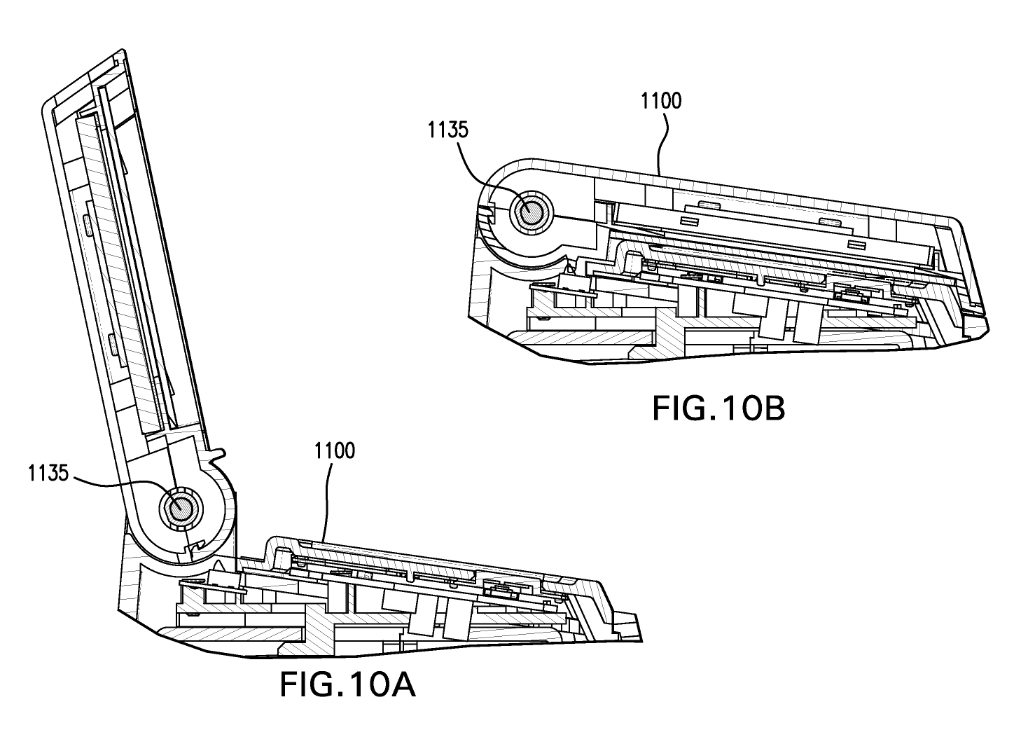

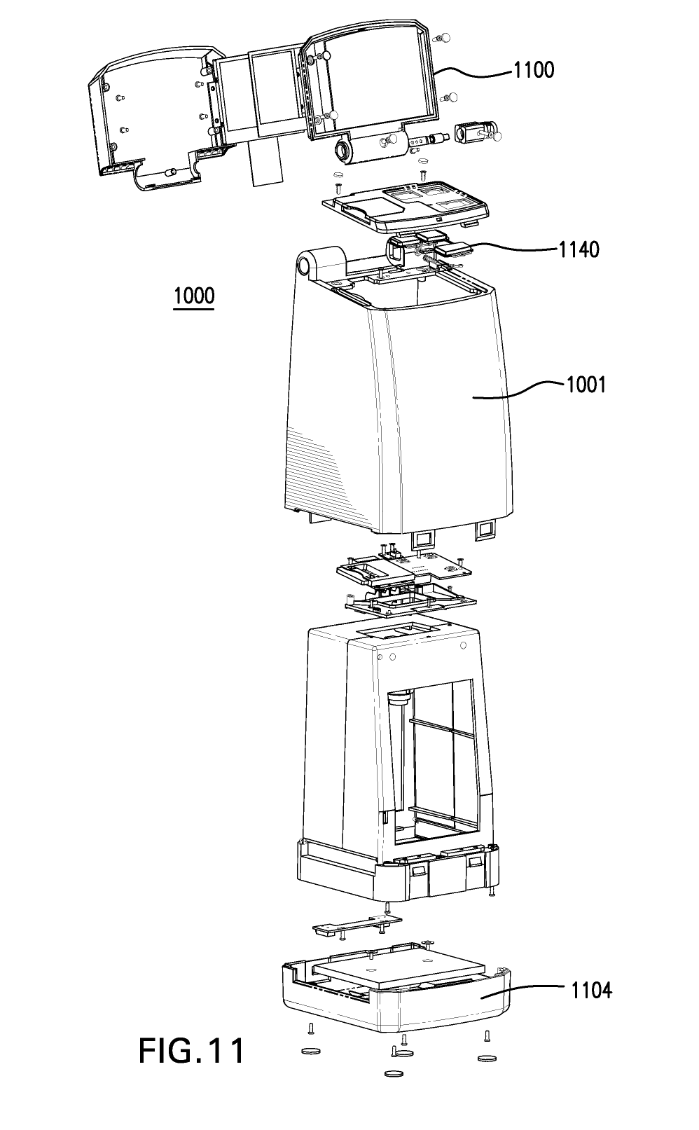

As shown in FIGS. 10A, 10B and 11, another embodiment of the film conversion device (1000) may also be provided that operates on a stand alone basis. To operate independently of a general computing device, the film conversion device (1000) may also include a display (1100), memory (1200) and a processing unit (1300). The display (1100) may be comprised of existing technology, such as a Thin Film Transistor display (“TFT”), a cathode ray tube (“CRT”), a liquid crystal display (“LCD”), a flat screen monitor, a touch screen monitor or similar means for displaying textual and graphical data to a user, or it may incorporate later developed technology that achieves this same purpose. The display (1100) may also require a video adapter and display memory, but this technology is well-known in the industry and various manners from enabling a display (1100) may be incorporate without departing from the teachings of this disclosure.

The processing unit (1300) is a hardware device for executing software, particularly software stored in memory (1200). Processing unit (1300) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 402 may also represent a distributed processing architecture such as, but not limited to, SQL, Smalltalk, APL, KLisp, Snobol, Developer 200, MUMPS/Magic.

For example, the alternative embodiment shown in FIGS. 10 and 11 may include a color TFT display 1100 that accesses images that are stored on memory 1200, such as a removable SD card. The display 1100 may be any standard size, but ideally the display 1100 will be between 1.5″ to 3.5″. In fact, in this embodiment of the present invention, the display 1100 is a 2.5″ screen and has dimensions of 90 mm×96.5 mm×170 mm.

As shown in FIGS. 10A, 10B and 11, the display 1100 may be attached to an upper portion of the body 1001 of the film conversion device 1000 and may be capable of assuming an open and a closed position. To achieve the open and closed positions, the display 1100 may be attached to the film conversion device by a hinge 1135. The conversion device may also be activated based on the position of the display 1100; in other words, when the display 1100 is in the open position, the conversion device 1000 will power up and when the display 1100 is in the closed position, the conversion device 1000 will power down. FIGS. 10A and 10B depict the display 1100 in the open position (FIG. 10A) and the closed positions (FIG. 10B). As shown in FIG. 11, when the display 1100 is in the open position, various buttons 1140 may be accessible to the user. The buttons 1140 located on the housing 1001 may include a menu button 1140a, a start button 1140b, forward and backward buttons 1140c, and any other buttons that may assist the user in capturing, storing and editing images.

The resolution of the display 1100 may be between 480 (RGB) and 234 megapixels, but the present embodiment is designed to display up to 5 megapixels of resolution. It is also possible for the display 1100 to be attached to different portions of the body 1001 or bottom cover 1004, so long as it is easily accessible, and for the display 1100 to swivel or pivot to allow for easier viewing by the user.

The display 1100 may function to display previews of the captured images, to display captured images that are stored on the memory 1200, or to allow users to edit captured images. The display 1100 will be compatible with JPEG images, but it may also display images in other formats that are known in the industry. The conversion device 1000 may also include an external video output 1110 for displaying captured images on an external display 1120 or television. For printing captured images, the film converter 1000 may also include a printer port or serial port 1250 for direct connection to an external printer. The film converter 1000 may be powered by an AC/DC adapter, via a USB cable that is connected to a independent computer, or batteries.

To allow users to edit captured images via the display 1100, the display 1100 may include a menu 1130. The menu may include options for navigating through the library of photos that are stored on the memory 1200, editing captured images, changing user or display settings on the conversion device 1000, or performing other functions that are standard in the digital image and photo processing industry. To add the above-referenced functionality and to assist with file format conversion, additional firmware or software may be added. Firmware and software to accomplish these functions is well-known in the industry.

The firmware or software that is executed by the processing unit (400) may include one or more separate programs. The separate programs comprise ordered listings of executable instructions for implementing logical functions. The software may also operate in accordance with a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system essentially controls the execution of computer programs and provides scheduling, input-output control, file and data management, memory management, and communication control and related services.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

We claim:

1. A film conversion device for converting film images into digital data, including:
a body for housing a film conversion unit;
a bottom cover for cooperating with the body to create an enclosed space;
a camera lens and image sensor positioned within the upper portion of the body and enclosed space;
an inlet opening and an outlet opening formed on opposite walls of the bottom cover and the respective sides of the body; and
a film clamp for holding film, the film clamp capable of being inserted through the inlet opening;
a back light mechanism mounted on the bottom cover and positioned below the film clamp, wherein the back light mechanism is able to project an image that is stored on the film onto the camera lens for conversion into digital data;
a display for depicting images that are captured by the camera lens; and
wherein the image is converted to digital data in a single step and without scanning the image on a line-by-line basis.

2. The device claimed in claim 1, wherein the camera lens may be attached to a printed circuit board assembly that includes a connecting cable to be extended out, the outer end of the connecting cable further including a connector to connect the device with a computer to upload the digital data for modification and storage.

3. The device claimed in claim 2, wherein the connector is a universal serial bus (“USB”) connection.

4. The device claimed in claim 1, wherein the inlet opening includes an inlet dust-proof door and the outlet opening includes an outlet dust-proof door.

5. The device claimed in claim 1, wherein the film conversion device is a stand-alone device and does not require connection to any other device in order to convert film images into digital data.

6. The device claimed in claim 1, wherein the display is a thin film transistor (“TFT”) display.

7. The device claimed in claim 6, wherein the display is compatible with JPEG images.

8. The device claimed in claim 6, wherein the display is mounted on the top of the body.

9. The device claimed in claim 6, wherein the display may be positioned in either an open position or a closed position.

10. The device claimed in claim 9, wherein when the device is in the open position, the device is powered up.

11. The device claimed in claim 9, wherein when the device is in the closed position, the device powers down.

12. The device claimed in claim 1, wherein the film conversion device further includes memory for storing images that are captured by the camera lens.

13. The device claimed in claim 12, wherein the memory is a removable SD card.
